(19) United States
(12) Patent Application Publication
(10) Pub. No.: US 2006/0107874 A1
(43) Pub. Date: May 25, 2006

(54) Method for accelerating setting of a hydraulic mineral binder composition with added adjuvant including hydrophilic functions, and composition obtainable by said method and use thereof

(76) Inventors: Jean-Christophe Castaing, Paris (FR); Pascal Taquet, Saint Leu (FR); Luc Nicoleau, Luthenay Uxeloup (FR); Andre Nonat, Epagny (FR)

Correspondence Address: Jean Louis Seugnet;Rhodia Inc CN 7500, Intellectual Property Department, 259 Prospect Plains Road, Cranbury, NJ, 08512-7500, US

(21) Appl. No.: 10/519,286

(22) PCT Filed: Jun. 27, 2003
(86) PCT No.: PCT/FR03/01991

§ 371 Date: Sep. 21, 2005

(30) Foreign Application Priority Data
Jun. 28, 2002 (FR) 02 08088

(51) Int. Cl. C04B 28/00; C04B 7/00

(52) U.S. Cl. 106/638

(57) ABSTRACT

The invention concerns a method for accelerating setting of a hydraulic mineral binder composition with added adjuvant including hydrophilic functions. The invention also concerns a composition of hydraulic mineral binders obtainable by said method to accelerate setting. The invention further concerns the use of said hydraulic mineral binder composition in the building industry, civil engineering or oil industry.

The invention relates to a method for accelerating the setting of a hydraulic inorganic binder composition to which has been added an additive comprising hydrophilic functional groups.

The invention also relates to a hydraulic inorganic binder composition capable of being obtained by this method for accelerating setting.

The invention also relates to the use of this hydraulic inorganic binder composition in the construction, civil engineering or oil industry.

Hydraulic binders are generally based on cement. They can be in the form of grouts, mortars or concretes. They are used, for example, in the following applications: tiling bonding cements, smoothing and finishing coatings, adhesives and coatings for insulating complexes, repair mortars, leaktight coatings and grouts for the cementation of oil wells. Nevertheless, some problems common to these applications have been observed, namely:
the adhesion to a support which is often not very rough,
differential shrinkages of the hydraulic binder with respect to the support and sometimes with respect to the component to be adhesively bonded,
volume deformations due to variations in the water content.

The development and the use of hydrophilic additives and in particular of film-forming polymers comprising hydrophilic groups in these mortars have, since 1960, provided noteworthy solutions to these problems, to the point that they have become commonplace and gradually essential. In addition, they have contributed other properties after curing of the hydraulic inorganic binder compositions, such as adhesion to various substrates, leaktightness, flexibility and mechanical properties.

In point of fact, it is found that the presence of these hydrophilic additives has disadvantages in the application targeted.

In particular, when use is made of a hydraulic binder to which has been added an additive comprising hydrophilic functional groups, a significant increase in the setting time for this hydraulic binder has been observed, more particularly when the hydraulic binder is based on Portland cement. This phenomenon is even more marked when the hydraulic binder is based on CPA CEM I 52.5 Portland cement.

This disadvantage can prove to be completely unacceptable in uses in the field of construction, where the waiting times before being able to carry out the following operation are always as short as possible.

Furthermore, these hydraulic binders to which have been added hydrophilic additives also exhibit the disadvantage of reducing the open time, that is to say the time during which the user can wait before positioning the tile when said hydraulic binder is used in an adhesive mortar.

The present invention has been developed in order to solve the abovementioned problems.

One of the aims of the present invention is to provide a method for producing a hydraulic binder composition to which has been added an additive comprising hydrophilic functional groups which does not exhibit the abovementioned disadvantages.

Another aim of the present invention is to provide a method for accelerating the setting of a hydraulic binder composition to which has been added an additive comprising hydrophilic functional groups.

Another aim of the present invention is to provide a method for increasing the open time of a hydraulic binder composition to which has been added an additive comprising hydrophilic functional groups.

These aims and others are achieved by the present invention as the latter relates to a method for accelerating the setting of a hydraulic inorganic binder composition to which has been added an additive comprising hydrophilic functional groups, characterized in that a sufficient amount of calcium silicate hydrates is added to the hydraulic inorganic binder composition to which has been added an additive comprising hydrophilic functional groups.

The invention also relates to a hydraulic inorganic binder composition capable of being obtained by this method for accelerating setting.

The invention also relates to the use of this hydraulic inorganic binder composition in the construction, civil engineering or oil industry.

Thus, a subject matter of the present invention is first of all a method for accelerating the setting of a hydraulic inorganic binder composition to which has been added an additive comprising hydrophilic functional groups, characterized in that a sufficient amount of calcium silicate hydrates is added to the hydraulic inorganic binder composition to which has been added an additive comprising hydrophilic functional groups.

The term “calcium silicate hydrates” or “CSH” is understood to mean, within the meaning of the invention, compounds of following formula (I):
aCaO.SiO₂.bAl₂O₃.cH₂O.dX (I)
in which X represents an alkali metal chosen from Li, Na, K, Rb, Cs or their mixture, with

0≦a≦2

0≦b≦1

1≦c≦5

0≦d≦1

Use is preferably made of compounds of formula (I) in which:

0≦a≦0.66

0≦b≦1

1≦c≦5

0≦d≦0.4

CSH can be prepared by synthetic methods known to a person skilled in the art. Mention may in particular be made of pages 132 et seq. in the book entitled “Cement Chemistry”, 2nd edition, H.F.W. Taylor, Thomas Telford Services Ltd, 1997, which are incorporated by reference.

They are generally prepared by suspending a mixture of the following compounds:
lime, prepared by calcination/decarbonation of calcite at 1000° C.;
and precipitated silica,
   the mixture being stirred for one week, then filtered and dried.

The drying is an important parameter in the preparation and it is preferable to carry out rinsing with acetone followed by rinsing with ether, in order to obtain very good drying of the calcium silicate hydrate composition.

Any other synthetic method starting from hydration of cement in dilute suspension or starting from powders possessing pozzolanic properties can also be used.

In the specific case where a, b and d are zero, the compound of formula (I) represents silica.

Good results have been obtained using silica having a high specific surface, such as, for example, precipitated silica or silica of aerosil type.

The term “silica of high specific surface” is understood to mean a silica having a specific surface of at least 200 m²/g and preferably of at least 300 m²/g.

The calcium silicate hydrates or the silica of high specific surface have to be added in a sufficient amount to the hydraulic inorganic binder composition to which has been added an additive comprising anionic hydrophilic functional groups.

The term “sufficient amount” is understood to mean, within the meaning of the present invention, an amount sufficient to substantially reduce the effect of the delay in setting of the hydraulic inorganic binder compositions to which have been added an additive comprising anionic hydrophilic functional groups.

In point of fact, this effect of reducing the delay in setting depends on the amount and on the nature of the additive comprising hydrophilic functional groups present in the hydraulic inorganic binder.

This is the reason why it is preferable to express this amount in the form of a calcium silicate hydrate or silica of high specific surface/additive comprising hydrophilic functional groups ratio.

Generally, the amount of calcium silicate hydrates or of silica of high specific surface introduced into the hydraulic inorganic binder composition to which has been added an additive comprising anionic hydrophilic functional groups is between 0.5 and 200% by weight of dry calcium silicate hydrates or silica of high specific surface with respect to the weight of the dry additive comprising anionic hydrophilic functional groups.

Preferably, this amount is between 10 and 100% by weight of dry calcium silicate hydrates or silica of high specific surface with respect to the weight of the dry additive comprising anionic hydrophilic functional groups.

More preferably still, this amount is approximately 50% by weight of dry calcium silicate hydrates or silica of high specific surface with respect to the weight of the dry additive comprising anionic hydrophilic functional groups.

The level of 50% appears appropriate; an excessively high level of calcium silicate hydrates might result in poor final mechanical properties of the hydraulic inorganic binder composition.

The additive comprising hydrophilic functional groups can be a film-forming polymer comprising anionic hydrophilic groups.

Generally, the film-forming polymers in the form of an aqueous dispersion (latex) or in the form of redispersible powders are not stable toward polymerization or storage if they do not exhibit anionic hydrophilic groups at the surface of the particles.

This is why these groups are introduced during the emulsion polymerization by adding functionalized monomers or by adding surfactants.

The term “anionic hydrophilic groups” is understood to mean in particular carboxyl, sulfonate, phosphate, phosphonate, sulfate or boronate groups.

Preferably, carboxyl groups are used.

When it is desired to introduce carboxyl groups, use may be made, as monomer, of a monoacid comprising vinyl functional groups, such as acrylic acid, methacrylic acid or crotonic acid, or else of a diacid comprising vinyl unsaturation, such as fumaric acid, itaconic acid, maleic acid, citraconic acid, β-carboxyethyl acrylate or acrylamidoglycolic acid.

The synthesis of film-forming polymers comprising carboxyl groups is described in particular in the extract from the Encyclopedia of Polymer Science and Engineering, volume 8, pages 662-663, John Wiley & Sons Inc., 1987, the document U.S. Pat. No. 4,567,099 (Dow), the document U.S. Pat. No. 5,759,347 (BASF) and the document U.S. Pat. No. 5,750,618 (Bayer), incorporated by reference.

When it is desired to introduce sulfonate groups, use may be made, as monomer, of sodium vinylsulfonate, acrylamidomethylpropanesulfonic acid, styrenesulfonate, methallylsulfonate, allyloxyhydroxypropylsulfonate, sulfopropyl acrylate, bis(sulfopropyl) acrylate or bis(sulfopropyl) itaconate.

When it is desired to introduce sulfate groups, use may be made, as monomer, of sulfatoethyl methacrylate.

When it is desired to introduce phosphonate groups, use may be made, as monomer, of vinylphosphonic acid.

When it is desired to introduce phosphate groups, use may be made, as monomer, of the products of the reaction of a hydroxylated monomer with P₂O₅, such as, for example, hydroxyethyl methacrylate phosphate.

When it is desired to introduce boronate groups, use may be made, as monomer, of styreneboronate.

Use may also be made of surfactants, the hydrophilic end of which is composed of at least one sulfate, carboxylate, sulfonate, phosphate, phosphonate or boronate group.

The water-insoluble film-forming polymers are preferably based on vinyl acetate, styrene/butadiene, styrene/acrylate, acrylate and styrene/butadiene/acrylate homopolymers and copolymers.

The film-forming polymers preferably have a glass transition temperature of between approximately −20° C. and +50° C., preferably between 0° C. and 40° C. These polymers can be prepared in a way known per se by emulsion polymerization of monomers comprising ethylenic unsaturation using polymerization initiators and in the presence of conventional emulsifying and/or dispersing agents. The polymer content of the emulsion generally lies between 30 and 70% by weight, more specifically between 35 and 65% by weight.

Mention may be made, as monomers, of vinyl esters and more particularly vinyl acetate; alkyl acrylates and methacrylates, the alkyl group of which comprises from 1 to 10 carbon atoms, for example methyl, ethyl, n-butyl and 2-ethylhexyl acrylates and methacrylates; or vinylaromatic monomers, in particular styrene. These monomers can be copolymerized with one another or with other monomers comprising ethylenic unsaturation.

Mention may be made, as nonlimiting examples of monomers which can be copolymerized with vinyl acetate and/or acrylic esters and/or styrene, of ethylene and olefins, such as isobutene; vinyl esters of saturated, branched or unbranched, monocarboxylic acids having from 1 to 12 carbon atoms, such as vinyl propionate, “versatate” (registered trademark for esters of branched acids having from 9 to 11 carbon atoms), pivalate or laurate; esters of unsaturated mono- or dicarboxylic acids having 3 to 6 carbon atoms with alkanols having 1 to 10 carbon atoms, such as methyl, ethyl, butyl and ethylhexyl maleates and fumarates; vinylaromatic monomers, such as methylstyrenes or vinyltoluenes; vinyl halides, such as vinyl chloride or vinylidene chloride; or diolefins, particularly butadiene.

The emulsion polymerization of the monomers is carried out in the presence of an emulsifier and of a polymerization initiator.

The monomers employed can be introduced as a mixture or separately and simultaneously into the reaction medium, either before the beginning of the polymerization, all at once, or during the polymerization, by successive fractions or continuously.

Use is generally made, as emulsifying agent, of conventional anionic agents represented in particular by fatty acid salts, alkyl ether sulfates, alkyl-sulfonates, alkylaryl ether sulfates, alkylaryl-sulfonates, aryl sulfates, arylsulfonates, sulfo-succinates, alkyl phosphates of alkali metals, or salts of hydrogenated or nonhydrogenated abietic acid. Use may also be made of nonionic surfactants, such as, for example, ethoxylated fatty alcohols or ethoxylated alkylphenols.

They are employed in a proportion of 0.01 to 5% by weight with respect to the total weight of the monomers.

The emulsion polymerization initiator, which is soluble in water, is represented more particularly by hydro-peroxides, such as aqueous hydrogen peroxide solution, cumene hydroperoxide, diisopropylbenzene hydroperoxide or para-menthane hydroperoxide, and by persulfates, such as sodium persulfate, potassium persulfate or ammonium persulfate. It is employed in amounts of between 0.05 and 2% by weight with respect to the total of the monomers. These initiators are optionally combined with a reducing agent, such as sodium bisulfite or formaldehydesulfoxylate, polyethylene-amines, sugars: dextrose or sucrose, or metal salts. The amounts of reducing agent used vary from 0 to 3% by weight with respect to the total weight of the monomers.

The reaction temperature, which is a function of the initiator employed, is generally between 0 and 100° C. and preferably between 30 and 70° C.

Use may be made of a transfer agent, in proportions ranging from 0 to 3% by weight with respect to the monomer(s), generally chosen from mercaptans, such as n-dodecyl mercaptan or tert-dodecyl mercaptan; cyclo-hexene; or halogenated hydrocarbons, such as chloro-form, bromoform or carbon tetrachloride. It makes it possible to adjust the proportion of grafted polymer and the length of the grafted molecular chains. It is added to the reaction medium either before the polymerization or during the polymerization.

The film-forming polymers comprising hydrophilic groups can also be provided in the form of powders, it being possible for said powders to be redispersed in water. The redispersible polymer powders exhibit the advantage, with respect to the aqueous dispersions, of being able to be premixed with the cement in the form of ready-for-use pulverulent compositions.

The method for the preparation of the pulverulent composition formed of film-forming polymers comprising hydrophilic groups is a conventional method well known to a person skilled in the art, as disclosed, for example, in the document WO 97/15617.

According to a preferred form of the invention, the film-forming polymer of the composition according to the invention exhibits a surface comprising carboxyl groups and thus a degree of surface acidity.

Thus, it preferably exhibits a degree of surface acidity of between 80 and 1200 microequivalents of —COOH functional group per gram of polymer, preferably of between 100 and 600 microequivalents of —COOH functional group per gram of polymer.

This degree of surface acidity can be measured using the following method of quantitative determination: An aqueous dispersion or solution of polymer with a total volume of 100 ml and with a solids content of 5% is prepared in demineralized water brought beforehand to boiling for one hour and then cooled to ambient temperature in the 120 ml glass reactor.

This dispersion is stirred and its pH is adjusted to a value of between 10.0 and 10.5 with 10% sodium hydroxide solution.

Quantitative determination is subsequently carried out with a titrator (702 SM Titrino model from Metrohm), which introduces 0.1M hydrochloric acid into the polymer suspension or solution until a pH of 2 is achieved.

Quantitative determination is carried out in the presence of nitrogen bubbling, in order to prevent contamination by carbonate ions.

The data (pH as a function of the volume of acid) are subsequently transferred to a computer and adjusted numerically according to the least squares method with a model which simulates the quantitative determination of a mixture of weak acids. It is assumed that the medium comprises a population of several acids, the pKa of which is between 2 and 12. The numerical adjustment provides the amount of acids present in the sample for each value of pKa.

The amount of weak acids at the surface of the latexes is obtained by summing the number of moles of acids for which the pKa is between 4 and 8.5 in the sample. The value obtained, divided by the weight of the polymer (in g), gives the degree of acidity (in micro-equivalents/g).

The hydraulic inorganic binders can be chosen from cements which can be of Portland, high-alumina or blast-furnace type. Other compounds often added as additives to cement also exhibit hydraulic properties, such as fly ash or calcined shales. Mention may also be made of pozzolans, which, on reacting with lime, form calcium silicates and can thus be influenced by the CSH.

The formulation of the hydraulic binders for mortars or concretes to which have been added a film-forming polymer comprising hydrophilic groups (latex comprising hydrophilic functional groups) is identical to that of standard Portland cement mortars or concretes. The proportions of the mixture simply have to be adjusted in order to take into account the proportion of water present in the latex emulsion comprising hydrophilic functional groups and the sizeable effect of plasticization of the latex. Depending on the quantitative determination and the type of latex comprising hydrophilic functional groups employed, the water/cement (W/C) ratio will be between 0.30 and 0.40 (0.35 in the examples of the invention).

Thus, generally, the hydraulic binders for mortar or for concrete to which have been added a film-forming polymer comprising anionic hydrophilic groups comprise between 0.1% and 30% by weight of dry polymer with respect to the weight of the cement.

Preferably, the hydraulic binders for mortar or for concrete to which have been added a film-forming polymer comprising anionic hydrophilic groups comprise between 0.1% and 20% by weight of dry polymer with respect to the weight of the cement.

The hydraulic binder compositions of the invention can additionally comprise the additives generally used in this field, such as, for example, superplasticizers or silica fumes.

Furthermore, the Applicant Company has been able to demonstrate the following result: the effect of the calcium silicate hydrates on the reduction in the delay in setting of the hydraulic binder composition to which has been added an additive comprising hydrophilic functional groups is further improved if the calcium silicate hydrates are suspended with the additive comprising hydrophilic functional groups for a sufficiently long time before the addition of the additive comprising hydrophilic functional groups to the hydraulic inorganic binder.

Thus, when the additive comprising hydrophilic functional groups considered is a film-forming polymer comprising anionic hydrophilic groups (latex comprising hydrophilic functional groups), as is the case in Example 3.c, the delay in setting of the hydraulic binder composition is reduced by 2 when 50% by weight of calcium silicate hydrates with respect to the weight of dry polymer has been added at the same time as the cement, is reduced by 4 when the same amount of calcium silicate hydrates has been left in suspension with the latex comprising hydrophilic functional groups for 2 days before the addition of cement, and is reduced by 8 when the same amount of calcium silicate hydrates has been left in suspension with the latex comprising hydrophilic functional groups for 5 days before the addition of cement.

This period for equilibrating the calcium silicate hydrates with the latex comprising hydrophilic functional groups can be shortened by varying the temperature.

Thus, another subject matter of the invention is an improved method for accelerating the setting of a hydraulic inorganic binder composition to which has been added an additive comprising hydrophilic functional groups comprising the following stages:
1) a sufficient amount of calcium silicate hydrates or of a silica having a high specific surface is mixed with the additive comprising hydrophilic functional groups in an aqueous solution with stirring; and
2) the hydraulic inorganic binder composition is added to the mixture obtained in stage 1.

The duration of the mixing of stage 1 and the temperature are parameters which can be easily adjusted by a person skilled in the art in order to obtain the result which he desires.

A second possible embodiment for accelerating the setting of a hydraulic inorganic binder composition to which has been added an additive comprising hydrophilic functional groups comprises an additional stage, after stage 1, of drying the suspension obtained in stage 1.

The drying can be carried out by any method known to a person skilled in the art. Use is preferably made of a drying method suited to the production of a redispersible polymer powder, such as, for example, drying by atomization, as disclosed in the document WO 97/15617.

This powder, obtained on conclusion of the stage of drying the mixture obtained in stage 1, is stable toward storage and is rapidly and easily redispersed in the hydraulic inorganic binder composition.

Another subject matter of the present invention is the redispersible powder capable of being obtained on conclusion of the drying of the mixture obtained in stage 1.

This specific embodiment makes it possible to obtain, at the end of stage 2, a hydraulic inorganic binder composition to which has been added an additive comprising hydrophilic functional groups which does not exhibit the disadvantages of the prior art.

Another subject matter of the present invention is thus a hydraulic inorganic binder composition to which has been added an additive comprising hydrophilic functional groups capable of being obtained by the method described above.

All the definitions of the various ingredients of this method are indicated above.

The hydraulic inorganic binder compositions to which have been added hydrophilic additives of the invention exhibit good mechanical properties and a markedly reduced delay in setting.

When the hydraulic binder is a mortar, a positive effect of the calcium silicate hydrates on the reduction in the open time brought about by the presence of the additive comprising hydrophilic functional groups is additionally noticed, in particular when this additive is a film-forming polymer comprising anionic hydrophilic groups (latex comprising hydrophilic functional groups).

The hydraulic inorganic binder compositions of the invention can be used in any application for which a hydraulic binder is used. Mention may in particular be made of tiling bonding cements, smoothing and finishing coatings, adhesives and coatings for insulating complexes, self-leveling floor coatings, repair mortars, leaktight coatings and grouts for the cementation of oil wells.

The subject matter and the advantages of the present invention will become even more clearly apparent in the light of the various exemplary embodiments set out below.

### EXAMPLES

### Example 1

### Preparation of the Film-Forming Polymer Comprising Carboxyl Groups

In the examples which follow, the latex used is a Rhoximat 150 latex sold by Rhodia.

It is a colloidal suspension composed of polymer beads of submicronic size resulting from the copolymerization of styrene and butadiene; polyacrylic chains are subsequently grafted at the surface.

### Example 2

### Preparation of the Cement Paste

The cement used in these examples is CEM I PM-ES 52.5 cement, subsequently referred to as HTS.

The samples are mixed at a water/cement ratio by weight set at 0.35.

5% by weight of solid content of PSB150 latex are added, in order to resemble real instances of adhesive mortar formulations.

In the examples which follow, three types of CSH were used:
precipitated silica (a, b and e=0); sold by Rhodia under the name Tixosil T92 (CSH_{—}0)
CSH with a=0.66, b=0 and e=0 (CSH_{—}0.66)
CSH with a=1.5, b=0 and e=0 (CSH_{—}1.5)

The final two CSH types were synthesized by mixing lime, obtained by decarbonation of calcite (12 hours at 1000° C.), and T92 silica in the appropriate proportions in suspension in deionized distilled water (liquid/solid ratio=15).

The suspension is kept stirred at 25° C. for one week.

The CSH is subsequently isolated by filtration under vacuum on a sintered glass funnel and the residual water is removed by washing with acetone followed by washing with ether.

### Example 3

### Influence of the Addition of Silicate Inorganic Fillers on the Change in the Mechanical Properties of Cement Pastes to which have been Added a Latex.

1. Measurement of the Increase in the Cohesion Using a Device for Measuring Viscoelastic Properties

The setting of the cement paste to which a latex has or has not been added is monitored by dynamic rheometry using an ARES device for measuring viscoelastic properties (Rheometrics).

The increase in the cohesion is monitored by the measurement over time of the elastic modulus G′ of the sample.

During the measurement, a sinusoidal deformation of 1.5×10⁻⁵ rad, less than the critical deformation, is applied to the material, that is to say that the cement paste is not destructured.

The frequency is kept constant at 1 radian/second.

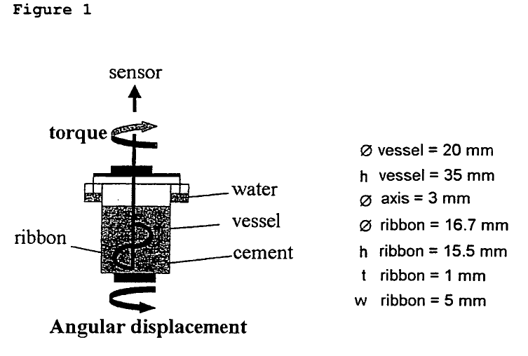

The geometry used (FIG. 1) is nonconventional of mixer type (Ait-Kadi, A., Marchal, P., Chrissemant, A. S., Bousmina, M., Choplin, L., “Mixer-type rheometry for complex fluids”, Rheology and Fluid Mechanics of Nonlinear Materials ASME, Vol. FED 243/MD 78, pp. 159-170 (1997)).

a) Comparison between a cement paste alone and a cement paste to which has been added a latex comprising hydrophilic functional groups.

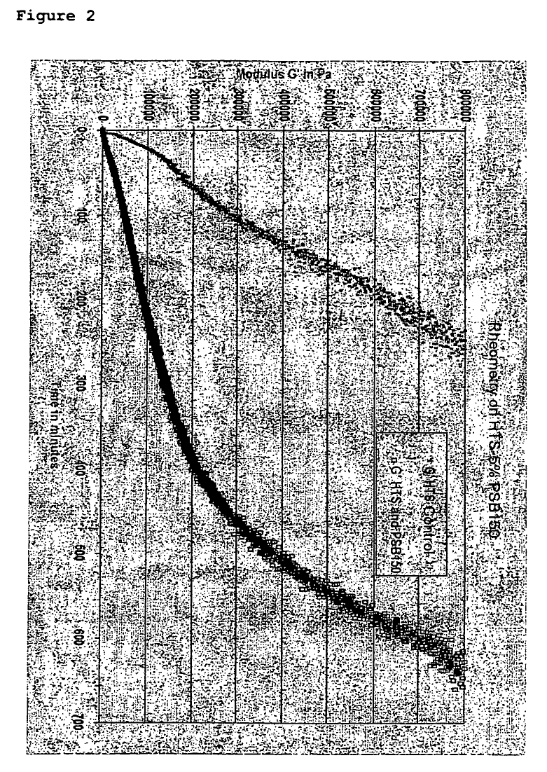

The change in the elastic moduli of the pure cement paste and of the paste to which has been added a latex comprising hydrophilic functional groups is presented in FIG. 2.

It is observed that the paste to which has been added a latex comprising hydrophilic functional groups acquires only a slight amount of mechanical strength over approximately 400 minutes, in contrast to the additive-free cement paste.

Thus, the cement matrix to which has been added a latex comprising hydrophilic functional groups exhibits a significant delay in setting.

b) Tests are carried out by adding calcium silicate hydrates to the cement matrix.

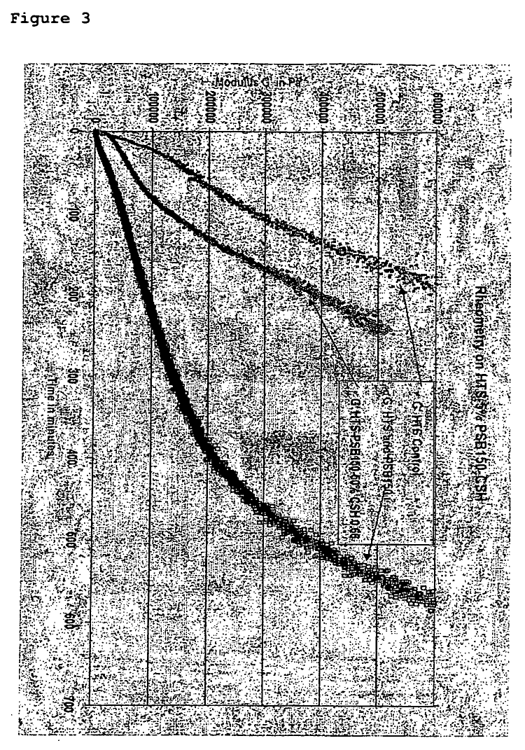

The reduction in the delay in setting obtained with an addition of 50% by weight of CSH_{—}0.66 with respect to the weight of the latex is presented in FIG. 3.

If the value of elastic modulus of 300 kPa is referred to as being able to be taken as indication of the beginning of setting, the addition of latex multiplies the setting time by 4.3, whereas the latex-CSH mixture multiplies it by only 1.7.

c) Tests are carried out by mixing, prior to the addition of hydraulic binder, the CSH and the latex comprising hydrophilic functional groups.

The prior mixing of the latex with the CSH further reduces the setting time, this reduction increasing as the duration of the mixing increases.

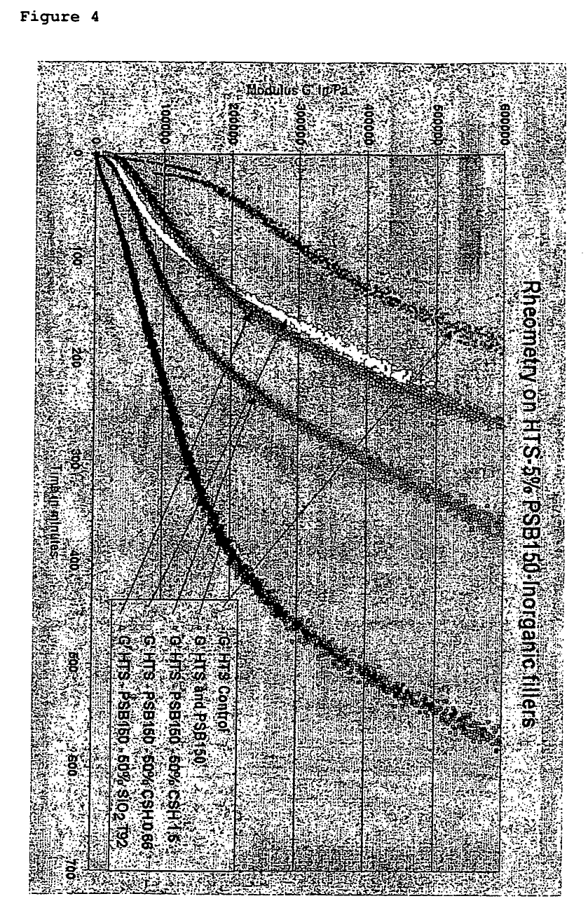

The results obtained with a CSH_{—}1.5 mixed in a Turbula at 25° C. with the latex and the amount of water necessary for the mixing of the cement are presented in FIG. 4.

The addition of 50% of CSH_{—}1.5 with respect to the weight of latex without prior mixing divides the setting time by 1.8, whereas, with a prior mixing of 48 h, the setting time is divided by 2.24, and 2.6 after a prior mixing of 120 h.

The calcium stoichiometry of the CSH, in other words the value of the coefficient a, also has an effect on the setting time. As is seen in FIG. 4, the smaller the ratio, the less the setting of the paste is delayed.

In the case where pure ultrafine silica Tixosil T92, sold by Rhodia, is added, a reduction in the delay in setting obtained of the same order of magnitude as in the case where CSH_{—}0.66 are used is observed.

2. Measurement of the Elastic Properties of the Cement Paste Using a Dynamic Rheometer

In addition to the reduction in the delay in setting brought about by the latex, the addition of CSH appears to improve the elastic properties of the cement paste.

These properties can also be evaluated by dynamic rheometry. In this case, at a given time, an increasing deformation is applied to the material; as long as the deformation is elastic, the modulus is constant; on the other hand, the reduction in the modulus with the increase in the deformation applied reflects the destruction of its structure.

In all the tests carried out, 50% of inorganic fillers were added with respect to the weight of latex.

The elastic limit of a pure cement paste corresponds to a deformation of approximately 0.0065%.

The addition of PSB150 latex to the cement paste considerably increases the deformation which can be withstood by the paste, since it is then approximately 0.02%.

The addition of a latex-CSH mixture further increases the maximum deformation which can be withstood by the paste, this increase becoming greater as the latex and the CSH are mixed for a long time prior to the addition of the cement paste.

Thus, when the latex and the CSH are mixed for a time of 5 days prior to the addition of the cement paste, the maximum deformation reaches 0.05%, i.e. more than double the deformation which can be withstood by the paste to which has been added the latex alone.

1-31. (canceled)

32. A method for accelerating the setting of a hydraulic inorganic binder composition to which has been added an additive comprising hydrophilic functional groups, comprising the step of adding to said composition a sufficient amount of calcium silicate hydrates or of silica with a high specific surface.

33. The method for accelerating the setting of a hydraulic inorganic binder composition to which has been added an additive comprising hydrophilic functional groups comprising the steps of:
a) adding to said additive a sufficient amount of calcium silicate hydrates or of silica of high specific surface in an aqueous solution with stirring; and
b) added to the suspension obtained in stage a) the hydraulic inorganic binder composition.

34. The method as claimed in claim 33, further comprsing an additional step of drying the suspension obtained in sttep a) until a powder is obtained.

35. The method as claimed in claim 34, wherein the drying is carried out by an atomization process.

36. The method as claimed in claim 33, wherein the calcium silicate hydrates are compounds of following formula (I):
aCaO.SiO₂.bAl₂O₃.cH₂O.dX (I)
in which:
X represents an alkali metal chosen from Li, Na, K, Rb, Cs or their mixture;
Wherein:
0≦a≦2
0≦b≦1
1≦c≦5
0≦d≦1
or, optionally, wherein:
0≦a≦0.66
0≦b≦1
1≦c≦5
0≦d≦0.4

37. The method as claimed in claim 3 6, wherein the calcium silicate hydrates are compounds of formula (I) in which a, b and d are zero, that is to say silica, optionally a precipitated silica.

38. The method as claimed in claim 37, wherein the silica has a specific surface is at least 200 m²/g, optionally at least 300 m²/g.

39. The method as claimed in claim 32, wherein the calcium silicate hydrate or silica is added in an amount of between 0.5 and 200%, optionally between 10 and 100%, by weight of dry calcium silicate hydrates or silica with respect to the weight of the dry additive comprising anionic hydrophilic functional groups.

40. The method as claimed in claim 40, wherein the amount of calcium silicate hydrates or of silica is approximately 50% by weight of dry calcium silicate hydrates or silica of high specific surface with respect to the weight of the dry additive comprising anionic hydrophilic functional groups.

41. The method as claimed in claim 32, wherein the additive comprising hydrophilic functional groups is a film-forming polymer comprising anionic hydrophilic groups.

42. The method as claimed in claim 41, wherein the anionic hydrophilic groups are carboxyl, sulfonate, phosphate, phosphonate, sulfate or boronate groups.

43. The method as claimed in claim 41, wherein the film-forming polymer is based on at least one vinyl acetate, styrene/butadiene, styrene/acrylate, acrylate, styrene/butadiene/acrylate homopolymer or copolymer.

44. The method as claimed in claim 41, wherein the film-forming polymer is prepared by an emulsion polymerization process and is in the form of an aqueous dispersion or in the form of a powder, it being possible for said powder to be redispersed in water.

45. The method as claimed in claim 41, wherein the film-forming polymer exhibits a surface comprising carboxyl groups and thus a degree of surface acidity, wherein the degree of surface acidity is between 80 and 1200, optionally between 100 and 600 microequivalents of —COOH functional group per gram of polymer.

46. The method as claimed in claim 41, wherein the hydraulic inorganic binders comprise between 0.1% and 30%, optionally between 0.1% and 20% by weight of dry polymer with respect to the weight of the hydraulic binder.

47. The method as claimed in claim 32, wherein the hydraulic binder is a cement selected from the group consisting of high-alumina Portland, blast-furnace Portland, fly ash, calcined shales or calcium silicates formed by the reaction of pozzolans with lime.

48. Tiling bonding cements, smoothing and finishing coatings, adhesives and coatings for insulating complexes, self-leveling floor coatings, repair mortars, leaktight coatings and grouts for the cementation of oil wells, comprising an hydraulic inorganic binder composition made by the method of claim 32.
